(19) United States
(12) Patent Application Publication
(10) Pub. No.: US 2026/0043893 A1
(43) Pub. Date: Feb. 12, 2026

(54) PHASE CORRECTION DEVICE AND METHOD

(71) Applicant: HL Klemove Corp., Incheon (KR)

(72) Inventors: Jin Gu LEE, Incheon (KR); Han Byul LEE, Incheon (KR); Jung Hwan CHOI, Incheon (KR)

(73) Assignee: HL Klemove Corp., Incheon (KR)

(21) Appl. No.: 18/952,615

(22) Filed: Nov. 19, 2024

(30) Foreign Application Priority Data
Aug. 12, 2024 (KR) 10-2024-0107897

(51) Int. Cl. G01S 7/03; G01S 13/08

(52) U.S. Cl. CPC G01S 7/03; G01S 13/08

(57) ABSTRACT

The present embodiments relate to a phase correction method, and may provide a phase correction device and method for transmitting and receiving a radar signal through a plurality of transmitting antennas and a plurality of receiving antennas, selecting a target among objects detected by a host vehicle based on a state of the host vehicle while in motion and a preset criterion, measuring a first phase value based on the radar signal reflected and received from the target, and determining a second phase value corresponding to an azimuth of the target based on a preset phase correction value, and determining a necessity of phase correction by comparing the first phase value and the second phase value, and changing the preset phase correction value based on a difference between the first phase value and the second phase value in response to determination of the necessity of phase correction.

### CROSS REFERENCE TO RELATED APPLICATION

This application claims priority from Korean Patent Application No. 10-2024-0107897, filed on Aug. 12, 2024, which is hereby incorporated by reference for all purposes as if fully set forth herein.

### TECHNICAL FIELD

An embodiment of the present disclosure relates to a device and method for correcting phase by comparing phase values.

### BACKGROUND

A radar device for a vehicle may be used to measure the distance, relative speed, and direction angle of other vehicles and stationary objects through surrounding monitoring in driver assistance systems or autonomous driving systems.

Specifically, the radar device may detect an azimuth of a target, that is, an angle between the line of sight to the target on the horizontal plane and the direction in front of the vehicle, to enable determination on whether driving is possible or whether the target is an actual obstacle. Accordingly, the radar device may be configured with a structure in which multiple physically separated receiving antennas are arranged so that the radar sensor has high angular resolution characteristics.

However, if contamination occurs inside or outside the radar device due to external factors, the phase component of the radar signal received through the receiving antenna may change. If the phase component of the radar signal changes, there is a problem that the accuracy of angular information calculation for the target decreases, and there is a problem that unexpected vehicle accidents may occur due to the inaccurate information on surrounding objects.

### SUMMARY

Embodiments of the present disclosure are to provide a device and method for correcting phase by comparing phase values.

In accordance with an aspect of the present disclosure, there may be provided a phase correction device including a signal transceiver for transmitting and receiving a radar signal through a plurality of transmitting antennas and a plurality of receiving antennas, a target selector configured to select a target among objects detected by a host vehicle based on a state of the host vehicle while in motion and a preset criterion, a phase determiner configured to measure a first phase value based on the radar signal reflected and received from the target, and determine a second phase value corresponding to an azimuth of the target based on a preset phase correction value, and a phase corrector configured to determine a necessity of phase correction by comparing the first phase value and the second phase value, and change the preset phase correction value based on a difference between the first phase value and the second phase value in response to determination of the necessity of phase correction.

In accordance with another aspect of the present disclosure, there may be provided a phase correction method including transmitting and receiving a radar signal through a plurality of transmitting antennas and a plurality of receiving antennas, selecting a target among objects detected by a host vehicle based on a state of the host vehicle while in motion and a preset criterion, measuring a first phase value based on the radar signal reflected and received from the target, and determining a second phase value corresponding to an azimuth of the target based on a preset phase correction value, and determining a necessity of phase correction by comparing the first phase value and the second phase value, and changing the preset phase correction value based on a difference between the first phase value and the second phase value in response to determination of the necessity of phase correction.

In accordance with another aspect of the present disclosure, there may be provided a phase correction device including at least one memory storing computer program instructions, and at least one processor for executing the computer program instructions, wherein the at least one processor may transmit and receive a radar signal through a plurality of transmitting antennas and a plurality of receiving antennas, may select a target among objects detected by a host vehicle based on a state of the host vehicle while in motion and a preset criterion, may measure a first phase value based on the radar signal reflected and received from the target, and determine a second phase value corresponding to an azimuth of the target based on a preset phase correction value, and may determine a necessity of phase correction by comparing the first phase value and the second phase value, and change the preset phase correction value based on a difference between the first phase value and the second phase value in response to determination of the necessity of phase correction.

According to an embodiment of the present disclosure, it is possible to provide a device and method for correcting phase by comparing phase values.

### BRIEF DESCRIPTION OF THE DRAWINGS

FIG. 1 is a diagram for explaining the configuration of a device for correcting a phase by comparing phase values according to one embodiment.

FIG. 2 is a flowchart for schematically explaining a process for correcting the phase of a signal by a phase correction device according to one embodiment.

FIG. 3 is a diagram for exemplarily illustrating the arrangement of a transmitting antenna and a receiving antenna according to one embodiment.

FIG. 4 is a diagram for explaining the configuration required for correcting the phase of a radar signal.

FIG. 5 is a diagram for specifically explaining a method for determining a lateral distance from a host vehicle to a structure according to one embodiment.

FIGS. 6A and 6B are diagrams for explaining a range-Doppler map according to one embodiment.

FIG. 7 is a diagram for explaining estimating a lateral distance between a host vehicle and a structure based on a determined correlation coefficient according to one embodiment.

FIGS. 8A and 8B are diagrams for explaining a phase value measured based on a radar signal and a phase value determined based on an azimuth of a target according to one embodiment.

FIGS. 9A and 9B are diagrams for explaining a determination on whether to correct a preset correction value based on the difference between a phase value measured based on a radar signal and a phase value determined based on the azimuth of a target according to one embodiment.

FIG. 10 is a flowchart for explaining an exemplary process of correcting a phase by comparing phase values according to one embodiment.

FIG. 11 is a flowchart for explaining a method of correcting a phase by comparing phase values according to one embodiment.

FIG. 12 is a block diagram of an exemplary computing system.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

In this specification, the “transmitting antenna” and the “receiving antenna” may mean an antenna for radiating a radar signal and receiving a reflected radar signal. For example, the antenna may be an antenna each composed of at least one patch antenna. Alternatively, the antenna may be a microstrip patch antenna. Alternatively, the antenna may be a waveguide antenna. However, there is no limitation on the type of the antenna as long as it is an antenna capable of radiating a radar signal and receiving a reflected radar signal.

A phase correction device according to one embodiment of the present disclosure may be installed in a vehicle, and may be a component of an advance driver assistance systems (ADAS) to provide information for assisting driving of the vehicle or to assist a driver in controlling the vehicle.

Here, ADAS may mean various types of advanced driver assistance systems, and driver assistance systems may include, for example, An autonomous Emergency Braking (AEB) system, a Smart Parking Assistance System (SPAS), a Blind Spot Detection (BSD) system, an Adaptive Cruise Control (ACC) system, a Lane Departure Warning System (LDWS), a Lane Keeping Assist System (LKAS), a Lane Change Assist System (LCAS), etc. However, the present disclosure is not limited thereto.

A host vehicle may refer to a car or a vehicle equipped with a motor or an engine and using the power to rotate wheels so that it moves on the ground without relying on railroad tracks or installed lines. In addition, the host vehicle may be an electric car which uses electricity as a power source and obtains driving energy by rotating a motor with electricity accumulated in a battery rather than obtaining driving energy from combustion of fossil fuels. The phase correction device of the present disclosure may be applied to a manned vehicle in which a driver rides and controls the host vehicle and an autonomous vehicle.

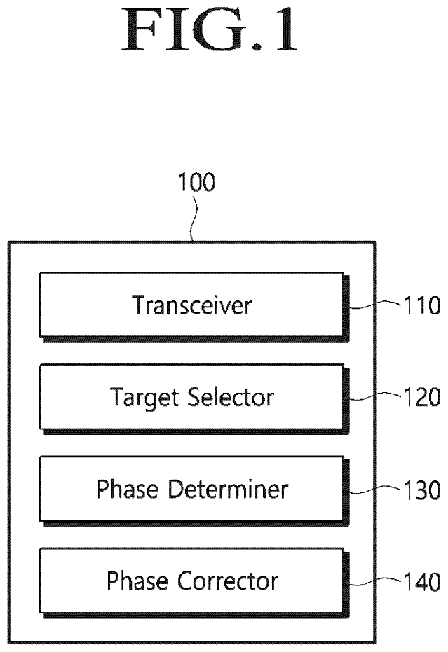

FIG. 1 is a diagram for explaining the configuration of a device for correcting a phase by comparing phase values according to one embodiment.

Referring to FIG. 1, the phase correction device 100 of the present disclosure may include a signal transceiver 110 which transmits and receives radar signals through a plurality of transmitting antennas and a plurality of receiving antennas.

The antenna may play a role in converting an electrical signal expressed as voltage/current and an electromagnetic wave expressed as an electric field/magnetic field. The antenna may detect a target and derive information about the target by transmitting a beam or radar signal having a shape with a specific directionality and magnitude.

In addition, the antenna may perform beamforming in which radiated energy is concentrated in a specific direction. The purpose of beamforming may be to receive a stronger signal from a desired direction or transmit a signal having more concentrated energy in a desired direction.

The phase correction device 100 of the present disclosure may include a plurality of transmitting antennas and a plurality of receiving antennas. The number and type of transmitting antennas and receiving antennas included in the phase correction device 100 are not limited.

Each transmitting antenna may be assigned for one transmitting channel, or a plurality of transmitting channels may be assigned to all of the plurality of transmitting antennas. The transmitting antenna may transmit a radar signal to the target through the transmitting channel.

Each receiving antenna may be assigned for one receiving channel, or multiple receiving channels may be assigned to all of the plurality of receiving antennas. The receiving antenna may receive a signal reflected from the target through the receiving channel.

In the present disclosure, if a radar signal is transmitted through a transmitting channel assigned to a transmitting antenna, there may be referred to as a radar signal being transmitted through the transmitting antenna, or there may be referred to as a radar signal being transmitted through the transmitting channel. In addition, if a radar signal is received through a receiving channel assigned to a receiving antenna, there may be referred to as a radar signal being received through the receiving antenna, or there may be referred to as a radar signal being received through the receiving channel.

The phase correction device 100 of the present disclosure may further include a chip for transmitting and receiving a radar signal, and the transmitting antenna or the receiving antenna and the chip may be connected to each other through a transmission line. There may not be assumed that the length of the transmission line used to connect each antenna and chip is always the same. In addition, each transmitting antenna may be arranged at a fixed distance apart, and each receiving antenna may be also arranged at a fixed distance apart. Accordingly, each radar signal received through each receiving channel may have a phase difference. For example, if a radar signal is transmitted to the target through a first transmitting channel assigned to a first transmitting antenna, and a radar signal reflected from the target and received through a first receiving channel assigned to a first receiving antenna and a radar signal reflected from the target and received through a second receiving channel assigned to a second receiving antenna may have a phase difference.

In this regard, there may be set a phase correction value for correcting the phase value for the receiving channel assigned to each receiving antenna during the design process of the radar device. However, since the results determined through the radar signal may vary due to various factors such as the relative arrangement of the antennas, the spacing between the antennas, or other surrounding environments, there may be cases where the preset phase correction value needs to be changed.

The present disclosure proposes a method of changing a preset phase correction value based on a comparison result between a phase value measured from a radar signal reflected from a target and received by the receiving antenna and a phase value determined based on an azimuth of the target, thereby accurately detecting a surrounding target through a radar signal.

The phase correction device 100 of the present disclosure may include a target selector 120 or a target selection unit for selecting a target among objects detected by the host vehicle based on a state of the host vehicle while the host vehicle is in motion and a preset criterion.

The phase correction device 100 of the present disclosure may select a target as a reference to determine whether phase correction or a change in phase correction value is necessary in the case that the host vehicle is in a straight driving state and a stationary object or a fixed object exists.

For example, the target selector 120 or the target selection unit of the present disclosure may determine whether the vehicle is in a straight driving state. The straight driving state of the host vehicle may be determined based on the amount of change in a path radius of the host vehicle. For example, if the amount of change in the path radius of the host vehicle is less than or equal to a preset threshold value, the target selector 120 of the present disclosure may determine that the host vehicle is in a straight driving state. Alternatively, if the amount of change in the path radius exceeds the preset threshold value, the target selector 120 of the present disclosure can determine that the vehicle is not in a straight driving state.

The change in the path radius of the host vehicle described above may be determined based on the yaw rate information and driving speed information of the host vehicle.

As another example, the phase correction device 100 of the present disclosure may select a target to determine the necessity of phase correction for a signal received through a receiving antenna. Specifically, the target selector 120 of the present disclosure may select a fixed object among objects located around the host vehicle as a target. The preset criterion described above may include a condition in which the target is required to be a fixed object or a stationary object.

An object located around the host vehicle may be classified into a moving object and a fixed or stationary object. The present disclosure may refer to an object located around the host vehicle as a target located around the host vehicle. In addition, the present disclosure may refer to a target used for phase correction as a reference target, an object, and a structure. The phase correction device 100 of the present disclosure may transmit a radar signal to an object located around the host vehicle through a transmitting antenna, and may receive the radar signal by reflecting from the object through a receiving antenna. The phase correction device 100 of the present disclosure may determine a position of an object, a distance from the host vehicle to the object, whether the object is a stationary object based on a signal received through a receiving antenna.

Therefore, the phase correction device 100 of the present disclosure may determine whether the host vehicle is driving in a straight line based on the amount of change in the path radius of the host vehicle, and determine whether an object located around the host vehicle is a stationary object based on a radar signal received through the receiving antenna, and determine an object satisfying both conditions as a reference target.

The phase correction device 100 of the present disclosure includes a phase determiner 130 which measures a first phase value based on a radar signal reflected from a target and received by the receiving antenna, and determines a second phase value corresponding to an azimuth of the target based on a preset phase correction value.

The phase correction device 100 of the present disclosure may preset each phase correction value in order to remove a phase difference of a radar signal according to an interval between receiving antennas. However, due to the influence of the surrounding environment, a problem may occur in which objects around the host vehicle are not properly detected by only the phase correction based on the preset phase correction value. Accordingly, the phase correction device 100 of the present disclosure may determine whether the preset phase correction value needs to be changed based on the difference between the phase value measured based on the received radar signal reflected from the selected target and the phase value determined based on the azimuth of the target, and the preset phase correction value may be changed if it is determined that a change in the preset phase correction is necessary.

For example, the azimuth of the target may be determined based on a lateral distance from the host vehicle to the target and a diagonal distance from the host vehicle to the point where the radar signal and the target come into contact.

Specifically, the azimuth of the target may be equal to an angle formed by a first line segment based on a diagonal distance from the host vehicle to the point where the radar signal and the target come into contact, and a second line segment formed in a vertical direction. In addition, the azimuth of the target may be determined based on a triangle including the first line segment, the second line segment, and a third line segment based on a lateral distance from the host vehicle to the target, and a sine formula which is a trigonometric function.

As another example, the lateral distance or a lateral range may be estimated based on a correlation coefficient determined between a first range-Doppler map generated by performing a Fast Fourier Transform (FFT) on the radar signal and a second range-Doppler map generated based on a comparison group including a plurality of preset temporary lateral distances.

As another example, the lateral distance may be estimated to be the same as a temporary lateral distance corresponding to a correlation coefficient if the correlation coefficient exceeds a preset value.

As another example, the second range-Doppler map may be generated with a value having peak power.

As another example, the diagonal distance or a diagonal range may be determined based on a speed and a round trip time of the radar signal. The round trip time of the radar signal may mean the time taken from when the radar signal is transmitted through the transmitting antenna to when it is reflected by the target and received through the receiving antenna.

The phase correction device 100 of the present disclosure may include a phase corrector 140 or a phase correction unit which compares a first phase value and a second phase value to determine the necessity of phase correction, and changes a preset phase correction value based on the difference between the first phase value and the second phase value if it is determined that phase correction is necessary.

The determination of the necessity of phase correction performed by the phase correction device of the present disclosure may mean the determination of the necessity of changing the preset phase correction value.

In addition, the phase correction of the present disclosure may mean correction of a preset phase correction value.

The first phase value may be a phase value measured from a received radar signal reflected from a target, and the second phase value may be a phase value determined based on the azimuth of the target, and comparing the first position value and the second phase value may mean comparing the difference between the first phase value and the second phase value with a preset threshold value.

If the difference between the first phase value and the second phase value exceeds a set threshold value, the preset phase correction value may be determined to require change, and if the difference between the first phase value and the second phase value is less than or equal to the set threshold value, the preset phase correction value may be determined not to require change.

For example, the phase correction device 100 may periodically accumulate the difference between the first phase value, which is a phase value measured based on a radar signal, and the second phase value, which is a phase value determined based on the azimuth of the target, and compare an average of the accumulated differences with the preset threshold value to determine whether phase correction is required. If it is determined that phase correction is required, the preset phase correction value may be changed based on the difference between the first phase value and the second phase value.

The phase correction device of the present disclosure may determine whether phase correction is necessary when the physical state of a device transmitting and receiving a signal changes due to an external factor, and if it is determined that phase correction is necessary, the device may change the phase correction value to accurately detect the presence, location, and moving speed of an object located around the vehicle, thereby preventing an unexpected accident.

Hereinafter, it will be described a phase correction method with reference to the accompanying drawings.

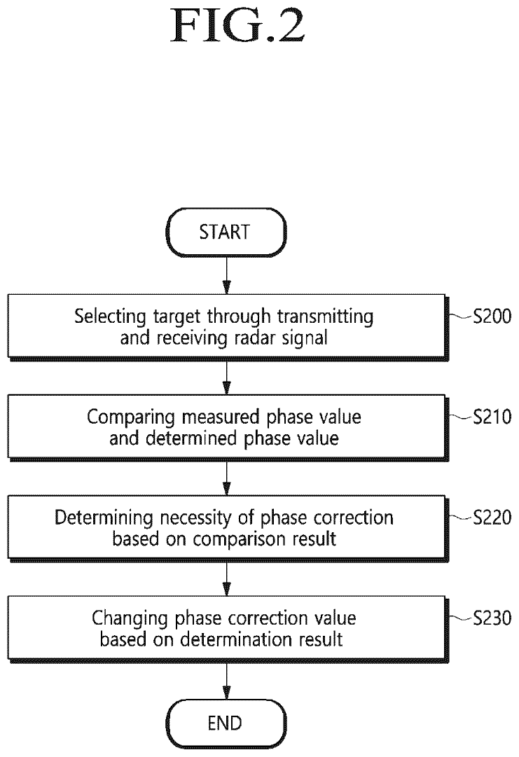

FIG. 2 is a flowchart for schematically explaining a process for correcting the phase of a signal by a phase correction device according to one embodiment.

Referring to FIG. 2, the phase correction device of the present disclosure may select a target for determining whether to perform phase correction, measure and determine a phase value for determination, and change the phase correction value based on the determination result.

The phase correction device of the present disclosure may select a target through a radar signal transmitted from a transmitting antenna and a radar signal reflected from a target and received by a receiving antenna (S200).

Specifically, the phase correction device of the present disclosure may select one of the fixed objects or the stationary objects located around the host vehicle as a reference target for phase correction when it is determined that the host vehicle is driving straight. The state of the straight driving of the host vehicle may be determined based on the amount of change in the path radius of the host vehicle, and whether an object is a fixed object may be determined based on a radar signal transmitted and received through an antenna.

In the present disclosure, it is important to determine a reference signal, a reference target, etc. necessary for determining whether or not to perform correction since the phase is required to be corrected online while the host vehicle is driving. In the case where the driving direction of the vehicle is not constant, there may decrease the accuracy of determination on whether or not phase correction is necessary. Therefore, the phase correction device of the present disclosure may select a reference target based on the vehicle being driven in a straight line and the target being a fixed object. For the convenience of explanation, it is assumed that the target is set to one, but this is only an example, and the target may change or be selected in multiple ranges depending on the driving situation of the vehicle.

If a reference target is selected, the phase correction device of the present disclosure may measure a phase value based on the radar signal used to select the target, determine a second phase value based on the azimuth of the target, and compare the difference between the measured phase value and the determined phase value with a preset threshold value (S210).

The phase correction device of the present disclosure may determine the phase value based on the azimuth of the selected target, and the azimuth or an azimuth angle may be determined based on the lateral distance from the host vehicle to the target and the diagonal distance from the host vehicle to the target. The diagonal distance from the host vehicle to the target may mean the distance from a point where the radar signal transmitted through the transmission antenna of the phase correction device of the present disclosure contacts the target to the host vehicle. The lateral distance from the vehicle to the target will be described in detail in the drawings below.

For example, the phase value measured based on the radar signal may be a phase value measured based on the radar signal received for each receiving channel. The phase correction device of the present disclosure may determine a receiving channel signal vector by reflecting the measured phase value. The receiving channel signal vector \vec{r} may be expressed by Equation 1. In Equation 1, α_{L} may be a preset parameter for calculating the difference between the measured phase value and the determined phase value, θ_{L} may be a measured phase value, φ_{e,L} may be a phase error value, and φ_{c,L} may be a preset correction value.

$$\vec{r} = [ \begin{matrix}{α}_{0} exp ( j ( {θ}_{0} + {ϕ}_{e , 0} + {ϕ}_{c , 0} ) ) \\ {α}_{1} exp ( j ( {θ}_{1} + {ϕ}_{e , 1} + {ϕ}_{c , 1} ) ) \\ ⋮ \\ {α}_{L - 1} exp ( j ( {θ}_{L - 1} + {ϕ}_{e , L - 1} + {ϕ}_{c , L - 1} ) )\end{matrix} ] \qquad [ Equation 1 ]$$

As another example, the phase value determined based on the azimuth of the target may be a phase value determined for each receiving channel, and the phase correction device of the present disclosure may determine the channel vector by reflecting the determined phase value.

Specifically, the azimuth of the target may be determined by determining the lateral distance from the host vehicle to the target and the diagonal distance from the host vehicle to the target. The azimuth of the target may be determined through Equation 2, where \hat{θ}ₜ may be the azimuth of the target, D_{y} may be the lateral distance from the host vehicle to the target, and R is the diagonal distance from the host vehicle to the target.

$${\hat{θ}}_{t} = {sin}^{- 1} ( \frac{{D}_{y}}{R} ) \qquad [ Equation 2 ]$$

If the azimuth of the target is determined, the phase value may be determined for each receiving channel, and the phase correction device of the present disclosure may determine the channel vector based on the determined phase value. The channel vector of the present disclosure may be determined through Equation 3, where \vec{a}(\hat{θ}ₜ) may be the channel vector, and \hat{θ}_{L} may be the determined phase value.

$$\vec{a} ( {\hat{θ}}_{t} ) = [ \begin{matrix}exp ( j ( {\hat{θ}}_{0} ) ) \\ exp ( j ( {\hat{θ}}_{1} ) ) \\ ⋮ \\ exp ( j ( {\hat{θ}}_{L - 1} ) )\end{matrix} ] \qquad [ Equation 3 ]$$

The phase value determined based on the azimuth may be determined differently for each receiving channel since the lateral distance from the host vehicle to the target may be determined based on the radar signal reflected from the target and received through the receiving antenna, and a phase difference may also occur in the radar signal due to the arrangement interval of the receiving antenna.

The phase correction device of the present disclosure may compare the difference between the measured phase value and the determined phase value with a preset threshold value to determine whether a different correction value other than the preset correction value is required to be applied to the measured phase value (S220).

For example, the measured phase value may mean the receiving channel signal vector described above, and the determined phase value may mean the channel vector. If the difference between the values determined for each receiving channel exceeds the preset threshold value, there may be determined that the preset correction value needs to be changed. In addition, if the difference between the values determined for each receiving channel is less than or equal to the preset threshold value, there may be determined that the preset correction value does not need to be changed. If it is determined that the preset correction value needs to be changed, the preset correction value may be changed based on the difference between a measured phase value and a determined phase value.

As another example, if the difference between the measured phase value and the determined phase value and the preset threshold value are compared with one data, the reliability of the comparison result may decrease. Therefore, the phase correction device of the present disclosure periodically accumulates the difference between the measured phase value and the determined phase value, and if the average of the accumulated results exceeds the preset threshold value, the preset phase correction value may be changed based on the difference between the measured phase value and the determined phase value. In this case, the necessity of changing the preset phase correction value for each receiving channel may be determined by using the receiving channel signal vector and the channel vector.

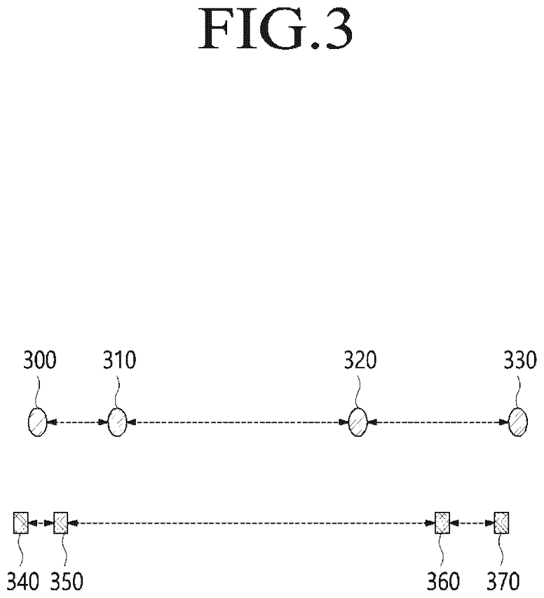

FIG. 3 is a diagram for exemplarily illustrating the arrangement of a transmitting antenna and a receiving antenna according to one embodiment.

Referring to FIG. 3, an antenna unit of the present disclosure may include a plurality of transmitting antennas and a plurality of receiving antennas arranged according to a set distance or interval and arrangement form.

For convenience of explanation, the present disclosure assumes that there are four transmitting antennas and four receiving antennas. However, the number of transmitting antennas and receiving antennas illustrated in FIG. 3 is only an example, and may be set in various ways as needed.

Referring to FIG. 3, the transmitting antennas of the present disclosure may be configured with four, and the receiving antennas may also be configured with four. In FIG. 3, the positions of the transmitting antennas are indicated with circles, and the positions of the receiving antennas are indicated with squares.

The four transmitting antennas of the present disclosure may be referred to as a first transmitting antenna 300, a second transmitting antenna 310, a third transmitting antenna 320, and a fourth transmitting antenna 330, and each antenna may be arranged spaced apart by a set distance. The separation distances or the intervals between each transmitting antenna may be all the same, may not be all the same, or may only be partly the same.

In addition, the present disclosure may refer to four receiving antennas as a first receiving antenna 340, a second receiving antenna 350, a third receiving antenna 360, and a fourth receiving antenna 370, and each antenna may be arranged to be separated by a set separation distance. The separation distances or the intervals between each receiving antenna may be all the same, may not be all the same, or may only be partly the same.

The separation distances between each transmitting antenna and the separation distance between each receiving antenna described may be set based on a preset unit separation distance, and the unit separation distance may be set to half a wavelength (0.5λ) of a frequency of a radar signal transmitted through the transmitting antenna. However, this is only one example, and may be set to various values such as ¼ wavelength (λ/4), ¾ wavelength (3λ/4), etc. as needed.

For example, the first transmitting antenna 300, the second transmitting antenna 310, the third transmitting antenna 320, and the fourth transmitting antenna 330 may be arranged in a straight line spaced apart from each other by a preset distance, and the first receiving antenna 340, the second receiving antenna 350, the third receiving antenna 360, and the fourth receiving antenna 370 may be arranged in a straight line different from the straight line in which the four transmitting antennas are arranged spaced apart from each other by a preset distance.

As another example, the straight line along which the first transmitting antenna 300, the second transmitting antenna 310, the third transmitting antenna 320, and the fourth transmitting antenna 330 are arranged, and the straight line along which the first receiving antenna 340, the second receiving antenna 350, the third receiving antenna 360, and the fourth receiving antenna 370 are arranged may be straight lines that are parallel to each other.

As another example, the first transmitting antenna 300, the second transmitting antenna 310, the third transmitting antenna 320, and the fourth transmitting antenna 330 may be arranged in an upper region of the straight line along which the first receiving antenna 340, the second receiving antenna 350, the third receiving antenna 360, and the fourth receiving antenna 370 are arranged.

As another example, the first transmitting antenna 300, the second transmitting antenna 310, the third transmitting antenna 320, and the fourth transmitting antenna 330 may be arranged in the lower region of the straight line where the first receiving antenna 340, the second receiving antenna 350, the third receiving antenna 360, and the fourth receiving antenna 370 are arranged.

The antenna arrangement method may include the NLA (Non-uniform Linear Array) antenna arrangement method or the SLA (Sparse Linear Array) antenna arrangement method in which a plurality of antennas are arranged at predetermined different intervals, and the ULA (Uniform Linear Array) antenna arrangement method in which the antennas are arranged at regular intervals. The transmitting antenna and the receiving antenna included in the phase correction device of the present disclosure may be arranged according to any one of the NLA antenna arrangement method, the SLA antenna arrangement method, and the ULA antenna arrangement method.

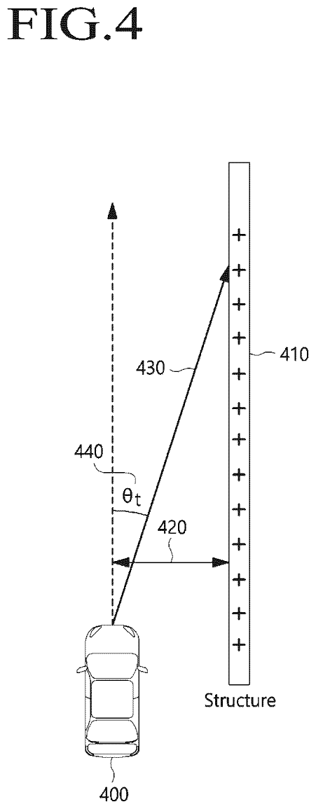

FIG. 4 is a diagram for explaining the configuration required for correcting the phase of a radar signal.

Referring to FIG. 4, in order to determine whether it is necessary to change the preset correction value for the phase of the radar signal received through each receiving antenna, there may be required to determine the speed of the host vehicle, the lateral distance between the hos vehicle and the target, the diagonal distance between the host vehicle and the target, the azimuth of the target, etc., and there is required to determine whether the host vehicle is driving in a straight line.

As described above, in order to accurately determine the necessity of the phase correction, there is required a condition in which the host vehicle 400 is driving in a straight line, and the target 410 is a fixed structure or a stationary structure.

Whether the host vehicle 400 is driving in a straight line may be determined based on the amount of change in the path radius of the host vehicle. The path radius of the host vehicle 400 may be determined by the yaw rate and driving speed of the host vehicle 400. In addition, if the change in the determined path radius exceeds a preset threshold, there may be determined that the host vehicle is not driving in a straight line, and if the change in the determined path radius is less than the threshold, there may be determined that the host vehicle is driving in a straight line.

Whether the target 410 is a fixed structure may be determined based on a radar signal transmitted from a plurality of transmitting antennas, reflected by the structure, and received by the receiving antenna.

In addition, a phase value may be measured based on a radar signal transmitted through the transmitting antenna, reflected by the structure, and received by the receiving antenna.

The determined phase value, which is a criterion for determining whether the measured phase value is normal, may be determined based on the azimuth 440 of the selected target. In addition, the azimuth 440 may be determined based on the lateral distance 420 from the host vehicle 400 to the target 410 and the diagonal distance 430 from the host vehicle 400 to the target 410. The diagonal distance 430 from the host vehicle 400 to the target 410 may refer to the distance from the host vehicle 400 to a point where the radar signal transmitted from the transmitting antenna and the target 410 come into contact.

The diagonal distance 430 may be determined based on the speed of the radar signal and the round trip time of the radar signal. For example, if the speed of the radar signal is 10 m/s and the round trip time of the signal is measured to be 1 second, the diagonal distance 430 may be determined as 10 m. As described above, the round trip time of the radar signal may refer to the time from when the radar signal is transmitted from the transmitting antenna to when the radar signal is reflected from the target and received by the receiving antenna.

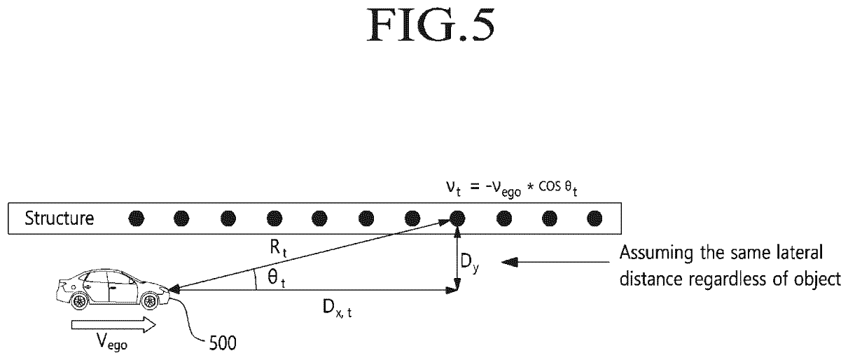

The method of determining the lateral distance 420 from the host vehicle 400 to the target 410 is explained in detail referring to FIG. 5.

If the lateral distance 420 and the diagonal distance 430 from the host vehicle 400 to the target 410 are determined, the azimuth of the target 410 may be determined based on the sine formula of the trigonometric function. For example, if the lateral distance is determined to be 10 m and the diagonal distance is determined to be 20 m, the azimuth may be determined to be 30°.

If the azimuth 420 is determined, the phase value of the radar signal may be determined, and there may be determined the necessity of the phase correction of the radar signal, and the preset phase correction value may be changed according to the determination result.

For comparison between the measured phase value and the determined phase value as described above, there may be expressed in vector form according to Equations 1 and 3 for each receiving channel.

FIG. 5 is a diagram for specifically explaining a method for determining a lateral distance from a host vehicle to a structure according to one embodiment.

Referring to FIG. 5, the phase correction device of the present disclosure may select a fixed object located around a host vehicle driving in a straight line as a target, and determine a lateral distance from the host vehicle to the target in order to determine the phase value for the target.

The phase correction device of the present disclosure may generate a first range-Doppler map by performing a fast Fourier transform (FFT) on a radar signal received through a receiving antenna, and may generate a second range-Doppler map based on a comparison group including a plurality of arbitrarily set targets and lateral distances, and may determine a correlation coefficient between the first range-Doppler map and the second range-Doppler map.

In relation to the generation of the range-Doppler map, the phase correction device of the present disclosure may transmit and receive a fast-chirp signal or a radar signal around the host vehicle. For example, the phase correction device of the present disclosure may utilize a fast-chirp radar sensor to generate a range-Doppler map based on a signal reflected from a surrounding object and received by a receiving antenna.

The phase correction device of the present disclosure may determine the range and time components by performing the first FFT (Fast Fourier Transform) on the received signal, and may compress the signal existing at each range according to the velocity component value by performing the second FFT on the time again to distinguish the signal components. In addition, the phase correction device may determine whether there is peak power for each coordinate in the range-Doppler domain and generate a detected peak map for the two-dimensional (2D) spectrum of the range-Doppler.

Specifically, the phase correction device of the present disclosure may generate a range-Doppler binary (Bin) map in which it is determined that there is peak power. Accordingly, the phase correction device may receive a signal by a side structure (e.g., clutter) with a strong intensity. Among the side structures, stationary objects such as guardrails may have different incident angles received by the radar sensor depending on the longitudinal distance due to their characteristics. That is, the relative speed of the signal may vary depending on the distance of the structure (e.g., stationary object).

In addition, if the received signal is orthogonal to the direction of travel of the host vehicle (i.e., target's azimuth θₜ+radar sensor mounting angle φ), the speed Vₜ of the corresponding signal may be determined as 0 m/s as in Equation 4 below, so that it may be difficult to estimate the driving speed V_{ego} of the host vehicle and the accurate relative speed to the target.

$${v}_{t} = {v}_{ego} * cos ( {θ}_{t} + φ ) \qquad [ Equation 4 ]$$

Therefore, if the lateral distance between the target and the host vehicle is estimated using a general method, there may be a ghost due to incorrect relative speed. To prevent this, there is required a time until sufficient targets are generated. In Equation 4 described above, the speed V_{ego} of the host vehicle may be obtained by detecting the wheel speed of the host vehicle from a speed sensor mounted on the host vehicle.

In the present disclosure, there may be recognized a structure or estimated a lateral distance to a structure based on a peak estimation process in a range-Doppler map, rather than a general target-based structure recognition method.

According to FIG. 5, the phase correction device of the present disclosure may generate a second range-Doppler map by utilizing the following Equations 5 and 6 based on a comparison group set to have a preset temporary lateral distance.

Specifically, a comparison group having a plurality of preset temporary lateral distances according to one embodiment may be expressed as Equation 5.

$${{D}_{y}}^{( n )} ∈ \{ 0.5 m , 0.6 m , … , 10. m \} , n = \{ 0 , 1 , … , 96 \} \qquad [ Equation 5 ]$$

In addition, each lateral distance value may be applied to Equation 4, so that the relative speed Vₜ may be calculated, in this case, Equations 6 and 7 below may be utilized.

$${D}_{x , t}^{( n )} = \sqrt{{( {R}_{k}^{( n )} )}^{2} - {( {D}_{y}^{( n )} )}^{2}} \qquad [ Equation 6 ]$$

$${θ}_{t}^{( n )} = {tan}^{- 1} ( \frac{{D}_{y}^{( n )}}{{D}_{x , t}^{( n )}} ) \qquad [ Equation 7 ]$$

Here, D_{x,t} is the longitudinal distance between the host vehicle and the target, D_{y} is the lateral distance between the host vehicle and the target, Rₜ is the diagonal distance between the host vehicle and the target, and θₜ is the angle between the host vehicle's traveling direction and Rₜ. The phase correction device of the present disclosure may determine the relative velocity or the relative speed corresponding to each lateral distance included in the comparison group, and generate a second range-Doppler map based on the values (e.g., lateral distance, relative velocity) at which peak power values corresponding to the corresponding range-Doppler points exist. That is, there may be generated as a range-Doppler binary map in which peak power values are 0 and 1.

The second range-Doppler map generated as described above may be expressed in Equation 8 as follows.

$${MAP}_{( n )} ( r , d ) , r = \{ 0 , ... , R - 1 \} , v = \{ 0 , ... , D - 1 \} \qquad [ Equation 8 ]$$

Here, R is the number of range bins, and D is the number of Doppler bins. The phase correction device of the present disclosure may generate a first range-Doppler map by applying a peak power map to a 2D spectrum in a range-Doppler domain determined by performing FFT on a received signal. In addition, the phase correction device of the present disclosure may determine a correlation coefficient between the first range-Doppler map and the second range-Doppler map. The correlation coefficient may be determined by utilizing the following Equation 9.

$${γ}_{( n )} = {\sum }_{v = 0}^{D - 1} {\sum }_{r = 0}^{R - 1} S ( r , d ) \cdot {MAP}_{( n )} ( r , d ) \qquad [ Equation 9 ]$$

Accordingly, the phase correction device of the present disclosure may estimate a lateral distance between the host vehicle and the target based on the determined correlation coefficient.

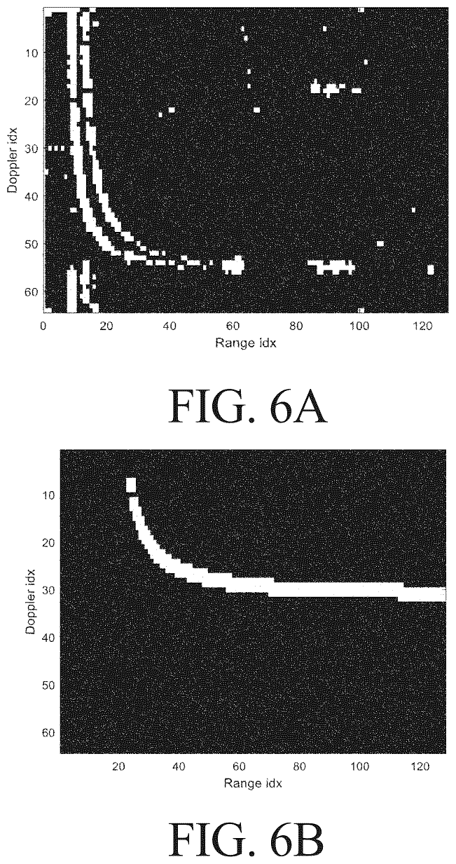

FIGS. 6A and 6B are diagrams for explaining a range-Doppler map according to one embodiment.

Referring to FIGS. 6A and 6B, FIG. 6A is a first range-Doppler map generated based on a received signal, and FIG. 6B is a second range-Doppler map generated based on a temporary lateral distance included in a comparison group. The phase correction device of the present disclosure may determine a temporary lateral distance having a high similarity by comparing the first range-Doppler map and the second range-Doppler map corresponding to the temporary lateral distance by determining a correlation coefficient. That is, the higher the similarity between the first range-Doppler map and the second range-Doppler map, the higher the correlation coefficient may be determined between the first range-Doppler map and the second range-Doppler map.

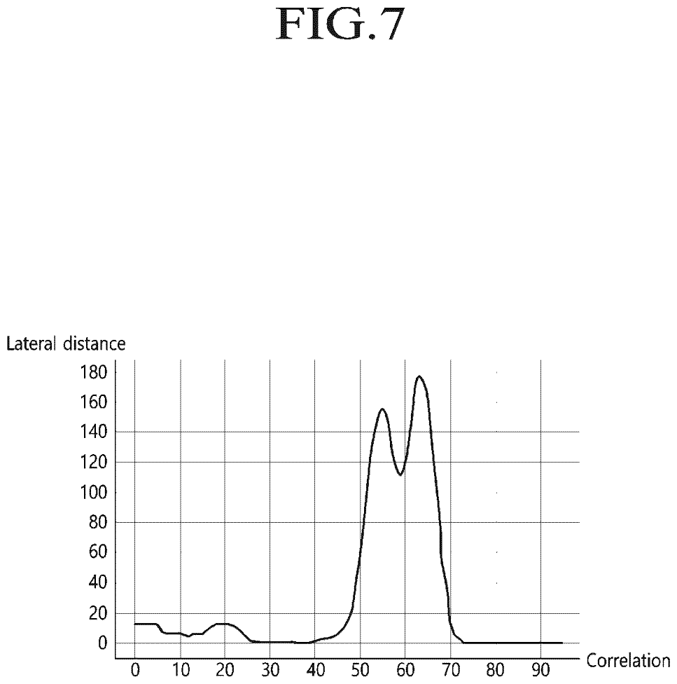

FIG. 7 is a diagram for explaining estimating a lateral distance between a host vehicle and a structure based on a determined correlation coefficient according to one embodiment.

Referring to FIG. 7, the phase correction device of the present disclosure may estimate the temporary lateral distance corresponding to the determined correlation coefficient as the lateral distance between the host vehicle and the target if the correlation coefficient exceeds a predetermined value. The maximum value of the correlation coefficient may be expressed by the following Equation 10.

$${n}_{max} = arg max {γ}_{( n )} \qquad [ Equation 10 ]$$

In addition, if the correlation coefficient exceeds the predetermined value (i.e., γₙ_{ₘₐₓ}>T), the phase correction device of the present disclosure may determine that the host vehicle is passing through a section of a long structure and store the temporary lateral distance value

$${D}_{y}^{( {n}_{max} )}$$

corresponding to the correlation coefficient. In the case that the determined correlation coefficient exceeds T, the phase correction device of the present disclosure may estimate the temporary lateral distance corresponding to the correlation coefficient as the lateral distance between the host vehicle and the target. In addition, the phase correction device of the present disclosure may estimate that a long structure exists around the road on which the host vehicle is traveling.

As described above, the phase correction device of the present disclosure may estimate a lateral distance between a host vehicle and a target more accurately by determining a correlation between a second range-Doppler map generated from a temporary lateral distance and a first range-Doppler map generated from radar measurements, thereby excluding targets having inaccurate speeds.

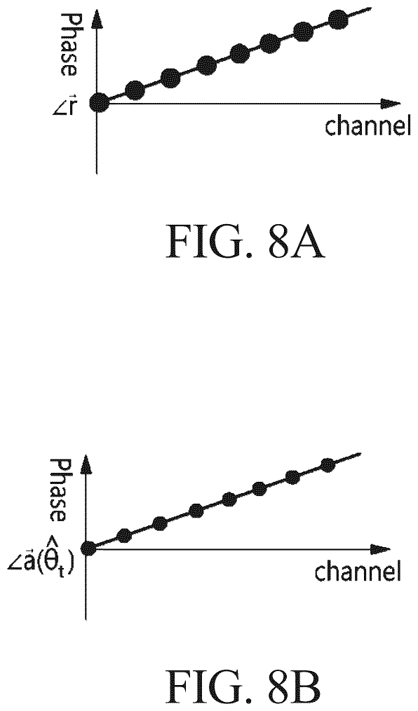

FIGS. 8A and 8B are diagrams for explaining a phase value measured based on a radar signal and a phase value determined based on an azimuth of a target according to one embodiment.

Referring to FIGS. 8A and 8B, the measured phase value and the determined phase value for the radar signal received for each receiving channel may be expressed as a graph.

As described above, since the plurality of transmitting antennas and the plurality of receiving antennas may have an interval between the antennas depending on the arrangement, a phase difference of the radar signal may occur.

As an example, FIG. 8A may express the measured phase value for each radar signal for each receiving channel as a graph when the radar signal is reflected by the target and received through each receiving antenna. As described above, the measured phase value for the radar signal may be determined through the receiving signal channel vector. The phase value of the radar signal received through each receiving channel may be expressed linearly as in FIG. 8A or nonlinearly depending on the interval of the receiving antennas.

As another example, FIG. 8B may express the phase value determined for each receiving channel based on the azimuth of the target as a graph. As described above, the phase value determined based on the azimuth of the target may also be determined through the receiving signal channel vector. Accordingly, the determined phase value may also be represented linearly or nonlinearly, as in FIG. 8A, depending on the intervals of the receiving antennas.

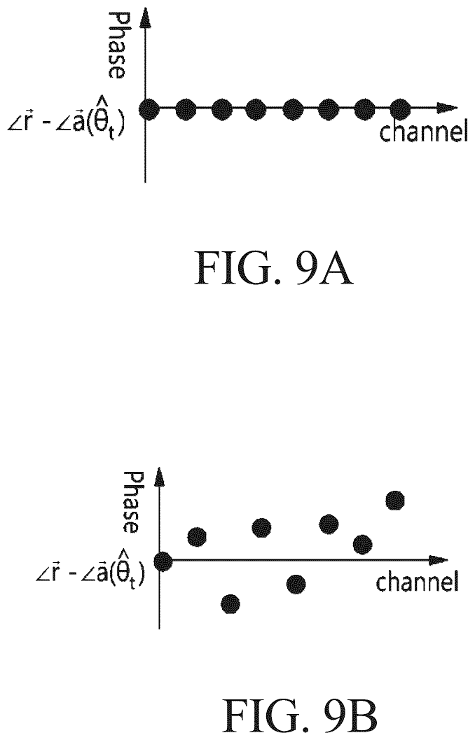

FIGS. 9A and 9B are diagrams for explaining a determination on whether to correct a preset correction value based on the difference between a phase value measured based on a radar signal and a phase value determined based on the azimuth of a target according to one embodiment.

Referring to FIGS. 9A and 9B, the difference between the measured phase value and the determined phase value for each receiving channel may be expressed as a graph.

For example, as in FIG. 9A, the difference between the measured phase value and the determined phase value for each receiving channel may be 0 for all receiving channels. This means that phase correction is not necessary.

However, the case where phase correction is not necessary is not limited to the case where the difference between the measured phase value and the determined phase value is 0. Even if the difference between the measured phase value and the determined phase value is less than or equal to a set threshold value, there may be determined that phase correction is not necessary.

As another example, FIG. 9B expresses that there are many cases where the difference between the measured phase value and the determined phase value for each receiving channel is not 0. This means that phase correction is required.

The phase correction device of the present disclosure may change a preset phase correction value for a radar signal for each receiving channel if it is determined that phase correction is necessary, as in FIG. 9B.

However, there may not be determined that phase correction is necessary for all receiving channels, and phase correction may be determined to be necessary only for receiving channels where the difference between the measured phase value and the determined phase value exceeds a set threshold value.

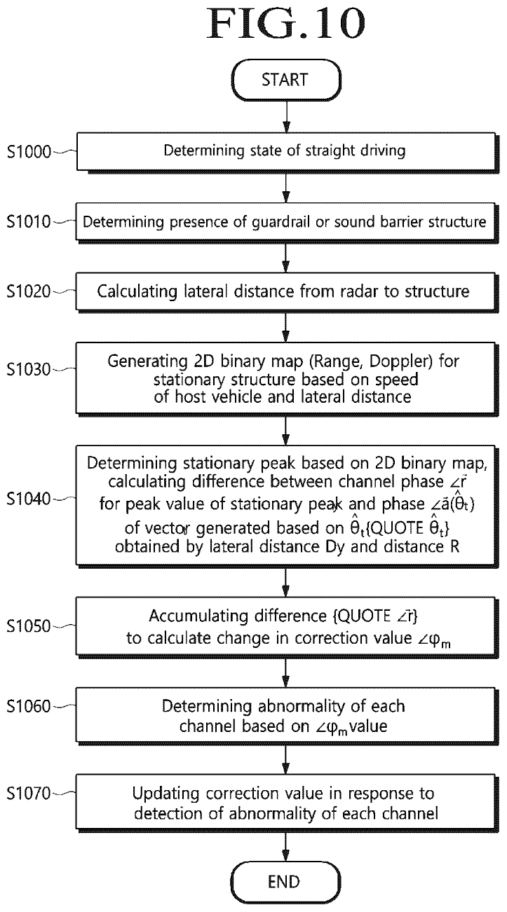

FIG. 10 is a flowchart for explaining an exemplary process of correcting a phase by comparing phase values according to one embodiment.

Referring to FIG. 10, the phase correction device may perform a process from selecting a target to changing a preset phase correction value for accurate detection of an object around the host vehicle.

The phase correction device of the present disclosure may determine whether the host vehicle is in a straight-line driving situation in order to select a target satisfying the specific criterion (S1000).

If the host vehicle is determined to be in a straight-line driving situation, there may be selected a target which is a fixed object (S1010).

As an example, the phase correction device of the present disclosure may select a fixed object such as a guardrail or a sound barrier structure located on a road as a target.

If a target is selected, the phase correction device may determine a lateral distance from the radar to the structure (S1020).

Although expressed only as a lateral distance, the lateral distance and diagonal distance from the radar to the structure may also be determined.

The phase correction device of the present disclosure may first determine the lateral distance from the radar to the structure in order to determine the azimuth of the target. In the present disclosure, a structure may be refer to as a target, the lateral distance may be refer to as a lateral distance, and the structure may be refer to as a target selected as a fixed object.

If the lateral distance is determined, the phase correction device may generate a 2D Binary map for the stationary structure based on the vehicle speed and lateral distance of the host vehicle (S1030).

If the 2D Binary map is generated, the phase correction device may determine a stationary peak through the generated map, and determine a phase value based on the measured phase for the stationary peak and the determined lateral distance and diagonal distance.

The phase correction device may accumulate the difference between the measured phase value and the determined phase value, and determine the amount of change in the correction value (S1040).

The amount of change in the correction value may mean the average of the accumulated results of the difference between the measured phase value and the determined phase value.

The phase correction device compares the average of the accumulated results with a preset reference value to determine the abnormal state of each channel (S1050).

Determination of the abnormal state of each channel may mean that the average of the accumulated results exceeds a preset threshold, and the abnormal state of each channel may mean that the preset phase correction value is required to be changed.

If an abnormal state of each channel is detected, the preset phase correction value may be updated (S1070).

The preset phase correction value may be changed based on the average of the accumulated results.

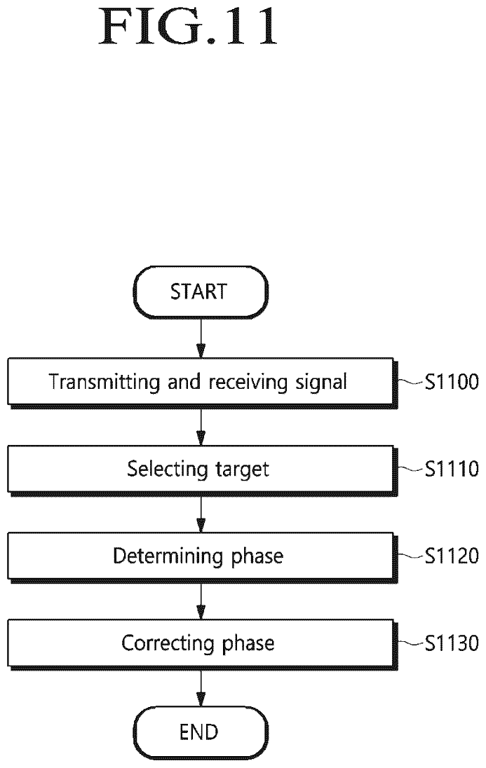

FIG. 11 is a flowchart for explaining a method of correcting a phase by comparing phase values according to one embodiment.

Referring to FIG. 11, the phase correction method of the present disclosure may include a step of transmitting and receiving a radar signal through a plurality of transmitting antennas and a plurality of receiving antennas (S1100).

The antenna may play a role of converting an electrical signal expressed as voltage/current and an electromagnetic wave expressed as an electric field/magnetic field into each other. The antenna may detect a target and derive information about the target by transmitting a beam or radar signal having a shape with a specific directionality and magnitude or intensity.

In addition, the antenna may perform beam-forming in which radiated energy is concentrated in a specific direction. The purpose of beam-forming is to receive a signal with a stronger intensity from a desired direction or to transmit a signal with more concentrated energy in a desired direction.

The phase correction device of the present disclosure may include a plurality of transmitting antennas and a plurality of receiving antennas. The number and type of transmitting antennas and receiving antennas included in the phase correction device are not limited.

Each transmitting antenna may be assigned one transmitting channel, or multiple transmitting channels may be assigned to all of the plurality of transmitting antennas. The transmitting antenna may transmit a radar signal to the target through the transmitting channel.

Each receiving antenna may be assigned one receiving channel, or multiple receiving channels may be assigned to all of the plurality of receiving antennas. The receiving antenna may receive a signal reflected from the target through the receiving channel.

In the present disclosure, when a radar signal is transmitted through a transmitting channel assigned to a transmitting antenna, there may be referred to as a radar signal being transmitted through the transmitting antenna, or there may be referred to as a radar signal being transmitted through the transmitting channel. In addition, when a radar signal is received through a receiving channel assigned to a receiving antenna, it may be referred to as a radar signal being received through the receiving antenna, or it may be referred to as a radar signal being received through the receiving channel.

The phase correction device of the present disclosure may further include a chip for transmitting and receiving a radar signal, and the transmitting antenna or the receiving antenna and the chip may be connected to each other through a transmission line. There may not be assumed that the length of the transmission line used to connect each antenna and chip is always the same. In addition, each transmitting antenna may arranged at a fixed distance apart, and each receiving antenna may also arranged at a fixed distance apart. Accordingly, each radar signal received through each receiving channel may have a phase difference. For example, a radar signal may be transmitted to the target through a first transmitting channel assigned to a first transmitting antenna, and a radar signal reflected from the target and received through a first receiving channel assigned to a first receiving antenna and a radar signal reflected from the target and received through a second receiving channel assigned to a second receiving antenna may have a phase difference.

In this regard, a phase correction value for correcting the phase value for the receiving channel assigned to each receiving antenna may be set during the design process of the radar device. However, since the results determined through the radar signal may vary due to various factors such as the relative arrangement of the antennas, the spacing or the interval between the antennas, or other surrounding environments, there may be cases where the preset phase correction value needs to be changed.

The present disclosure proposes a method of changing a preset phase correction value based on a comparison result between a phase value measured from a radar signal reflected from a target and a phase value determined based on the azimuth of the target, so that a surrounding target may be accurately detected through a radar signal.

The phase correction method of the present disclosure may include a step of selecting a target among objects detected by the host vehicle based on a state of the host vehicle while the host vehicle is in motion and a preset criterion (S1110).

The phase correction device of the present disclosure may select a target as a reference to determine whether a change in phase correction value is necessary when the vehicle is in a straight driving state and a fixed object exists.

For example, the step of selecting a target of the present disclosure may include a step of determining whether the host vehicle is in a straight driving state. Whether the host vehicle is driving straight may be determined based on the amount of change in the path radius of the host vehicle. For example, if the amount of change in the path radius of the driving host vehicle is less than or equal to a preset threshold value, there may be determined that the host vehicle is driving straight. Alternatively, if the amount of change in the path radius exceeds a preset threshold value, there may be determined that the host vehicle is not driving straight.

The amount of change in the path radius of the host vehicle described above may be determined based on the yaw rate information and the driving speed information of the host vehicle.

As another example, the phase correction device of the present disclosure may select a target to determine whether a signal received through a receiving antenna requires a phase correction, and the step of selecting the target of the present disclosure may include selecting a fixed object among objects located around the host vehicle as a target. That is, the above-described preset criterion may include a condition that the target is a fixed or stationary object.

Objects located around the host vehicle may be classified into moving objects and fixed objects. Targets utilized for phase correction may be referred to as reference targets, objects, and structures. The phase correction device of the present disclosure may transmit a radar signal to an object located around the host vehicle through a transmitting antenna, and may receive the radar signal through a receiving antenna by reflecting the object. The phase correction device of the present disclosure may determine the location, distance, and whether an object is a fixed object based on a signal received through a receiving antenna.

Therefore, the phase correction device of the present disclosure may determine whether the host vehicle is driving in a straight line based on the amount of change in the path radius, and determine whether an object located around the host vehicle is a fixed object based on a radar signal received through a receiving antenna, and determine an object satisfying both conditions as a reference target.

The phase correction method of the present disclosure may include a step of measuring a first phase value based on a radar signal reflected from a target, and determining a second phase value corresponding to the azimuth of the target based on a preset phase correction value (S1120).

The phase correction device of the present disclosure may preset each phase correction value in order to remove the phase difference of the radar signal according to the interval between the receiving antennas. However, due to the influence of the surrounding environment, a problem may occur in which objects around the host vehicle are not properly detected by only performing phase correction based on the preset phase correction value. Accordingly, the phase correction device of the present disclosure may determine whether it is necessary to change the preset phase correction value based on the difference between the phase value measured based on the radar signal reflected from the selected target and the phase value determined based on the azimuth of the target. In addition, if it is determined that there is a need to change the phase correction value, the preset phase correction value may be changed.

For example, the azimuth of the target may be determined based on the lateral distance from the host vehicle to the target and the diagonal distance from the host vehicle to a point where the radar signal and the target come into contact.

Specifically, the azimuth of the target may be determined based on a triangle including the first line segment based on the diagonal distance from the host vehicle to the point where the radar signal and the target come into contact, a second line segment formed in a vertical direction, and a third line segment based on the lateral distance from the host vehicle to the target, and a sine formula, which is a trigonometric function.

As another example, the lateral distance or the lateral range may be estimated based on a correlation coefficient determined between a first range-Doppler map generated by performing a Fast Fourier Transform (FFT) on the radar signal and a second range-Doppler map generated based on a comparison group including a plurality of preset temporary lateral distances.

As another example, the lateral distance may be estimated to be the same as the temporary lateral distance corresponding to the correlation coefficient if the correlation coefficient exceeds a preset value.

As another example, the second range-Doppler map may be generated as a value having peak power.

As another example, the diagonal distance may be determined based on the speed and round trip time of the radar signal. The round trip time of the radar signal may mean the time taken from when the radar signal is transmitted through the transmitting antenna until it is reflected by the target and received through the receiving antenna.

The phase correction method of the present disclosure may include a step of comparing a first phase value and a second phase value to determine the necessity of phase correction, and changing a preset phase correction value based on the difference between the first phase value and the second phase value if it is determined that phase correction is necessary (S1130).

The determination of necessity of phase correction performed by the phase correction device of the present disclosure may mean determination of necessity of changing the preset phase correction value.

In addition, the phase correction of the present disclosure may mean correction of the preset phase correction value.

The first phase value may be a phase value measured from a radar signal reflected and received from a target, and the second phase value may be a phase value determined based on the azimuth of the target, and comparing the first phase value and the second phase value may mean comparing the difference between the first phase value and the second phase value with a set threshold value.

If the difference between the first phase value and the second phase value exceeds the set threshold value, the preset phase correction value may be determined to require change, and if the difference between the first phase value and the second phase value is less than or equal to the set threshold value, the preset phase correction value may be determined to require no change.

For example, the phase correction device may periodically accumulate the difference between the first phase value, which is a phase value measured based on a radar signal, and the second phase value, which is a phase value determined based on the azimuth of the target, and compare the average of the accumulated differences with a preset threshold value to determine whether phase correction is necessary. In addition, if it is determined that phase correction is required, the phase correction device may change the preset phase correction value based on the difference between the first phase value and the second phase value.

Hereinafter, it will be described a phase correction device implemented as a computing system capable of performing some or all of the embodiments described with reference to FIGS. 1 to 11 with reference to the drawings. The above description may be omitted to avoid redundant description, and in this case, the omitted content may be substantially equally applied to the following description as long as it does not contradict the technical idea of the present disclosure.

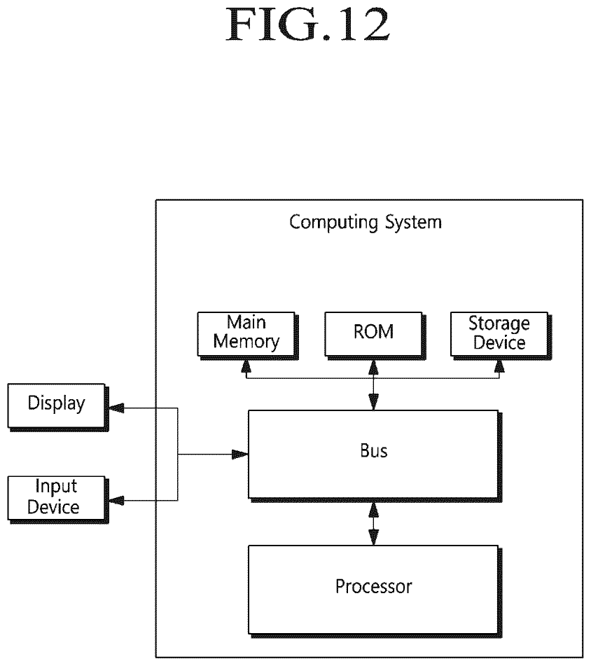

FIG. 12 is a block diagram of an exemplary computing system.

A phase correction device according to one embodiment of the present disclosure may include at least one memory storing computer program instructions, and at least one processor for executing the computer program instruction. In this case, the at least one processor may transmit and receive a radar signal through a plurality of transmitting antennas and a plurality of receiving antennas, may select a target among objects detected by a host vehicle based on a state of the host vehicle while in motion and a preset criterion, may measure a first phase value based on the radar signal reflected and received from the target, and determine a second phase value corresponding to an azimuth of the target based on a preset phase correction value, and may determine a necessity of phase correction by comparing the first phase value and the second phase value, and change the preset phase correction value based on a difference between the first phase value and the second phase value in response to determination of the necessity of phase correction.

The computer system or computing device can include or be used to implement the system or its components such as the data processing system. The computing system includes a bus or other communication component for communicating information and a processor or processing circuit coupled to the bus for processing information. The computing system can also include one or more processors or processing circuits coupled to the bus for processing information. The computing system also includes main memory, such as a random access memory (RAM) or other dynamic storage device, coupled to the bus for storing information, and instructions to be executed by the processor. The main memory can be or include the data repository. The main memory can also be used for storing position information, temporary variables, or other intermediate information during execution of instructions by the processor. The computing system may further include a read-only memory (ROM) or other static storage device coupled to the bus for storing static information and instructions for the processor. A storage device, such as a solid state device, magnetic disk or optical disk, can be coupled to the bus to persistently store information and instructions. The storage device can include or be part of the data repository.

The computing system may be coupled via the bus to a display, such as a liquid crystal display or active matrix display, for displaying information to a user. An input device, such as a keyboard including alphanumeric and other keys, may be coupled to the bus for communicating information and command selections to the processor. The input device can include a touch screen display. The input device can also include a cursor control, such as a mouse, a trackball, or cursor direction keys, for communicating direction information and command selections to the processor and for controlling cursor movement on the display. The display can be part of the data processing system, the client computing device or other component.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system,” “computing device,” “component,” or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field-programmable gate array) or an ASIC (application-specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A phase correction device comprising:
a signal transceiver for transmitting and receiving a radar signal through a plurality of transmitting antennas and a plurality of receiving antennas;
a target selector configured to select a target among objects detected by a host vehicle based on a state of the host vehicle while in motion and a preset criterion;
a phase determiner configured to measure a first phase value based on the radar signal reflected and received from the target, and determine a second phase value corresponding to an azimuth of the target based on a preset phase correction value; and
a phase corrector configured to determine a necessity of phase correction by comparing the first phase value and the second phase value, and change the preset phase correction value based on a difference between the first phase value and the second phase value in response to determination of the necessity of phase correction.

2. The phase correction device of claim 1, wherein the a state of the host vehicle includes a state in which the host vehicle is driving straight,
wherein the target selector determines whether the host vehicle is driving straight based on a change in a path radius of the host vehicle.

3. The phase correction device of claim 1, wherein the preset criterion includes a condition in which the object detected by the host vehicle is a fixed object.

4. The phase correction device of claim 1, wherein the azimuth is determined based on a lateral distance from the host vehicle to the target and a diagonal distance from the host vehicle to a point where the radar signal and the target come into contact.

5. The phase correction device of claim 4, wherein the azimuth is equal to an angle formed by a first line segment based on the diagonal distance and a second line segment formed in a vertical direction,
wherein the azimuth is determined based on a triangle including the first line segment, the second line segment, and a third line segment based on the lateral distance and a sine formula, which is a trigonometric function.

6. The phase correction device of claim 4, wherein the lateral distance is estimated based on a correlation coefficient determined between a first range-Doppler map generated by performing a Fast Fourier Transform (FFT) on the radar signal and a second range-Doppler map generated based on a comparison group including a plurality of preset temporary lateral distances.

7. The phase correction device of claim 6, wherein, if the correlation coefficient exceeds a preset value, the lateral distance is estimated to be equal to a temporary lateral distance corresponding to the correlation coefficient.

8. The phase correction device of claim 6, wherein the second range-Doppler map is generated by values having peak power.

9. The phase correction device of claim 4, wherein the diagonal distance is determined based on a speed and a round-trip time of the radar signal.

10. The phase correction device of claim 1, wherein the phase corrector periodically accumulates the difference between the first phase value and the second phase value, and determines that the phase correction is necessary if an average of the accumulated difference exceeds a preset threshold value,
wherein the phase corrector changes the preset phase correction value based on the average of the accumulated difference.

11. A phase correction method comprising:
transmitting and receiving a radar signal through a plurality of transmitting antennas and a plurality of receiving antennas;
selecting a target among objects detected by a host vehicle based on a state of the host vehicle while in motion and a preset criterion;
measuring a first phase value based on the radar signal reflected and received from the target, and determining a second phase value corresponding to an azimuth of the target based on a preset phase correction value; and
determining a necessity of phase correction by comparing the first phase value and the second phase value, and changing the preset phase correction value based on a difference between the first phase value and the second phase value in response to determination of the necessity of phase correction.

12. The phase correction method of claim 11, wherein the a state of the host vehicle includes a state in which the host vehicle is driving straight,
wherein the selecting includes determining whether the host vehicle is driving straight based on a change in a path radius of the host vehicle.

13. The phase correction method of claim 11, wherein the preset criterion includes a condition in which the object detected by the host vehicle is a fixed object.

14. The phase correction method of claim 11, wherein the azimuth is determined based on a lateral distance from the host vehicle to the target and a diagonal distance from the host vehicle to a point where the radar signal and the target come into contact.

15. The phase correction method of claim 14, wherein the azimuth is equal to an angle formed by a first line segment based on the diagonal distance and a second line segment formed in a vertical direction,
wherein the azimuth is determined based on a triangle including the first line segment, the second line segment, and a third line segment based on the lateral distance and a sine formula, which is a trigonometric function.

16. The phase correction method of claim 15, wherein the lateral distance is estimated based on a correlation coefficient determined between a first range-Doppler map generated by performing a Fast Fourier Transform (FFT) on the radar signal and a second range-Doppler map generated based on a comparison group including a plurality of preset temporary lateral distances.

17. The phase correction method of claim 16, wherein, if the correlation coefficient exceeds a preset value, the lateral distance is estimated to be equal to a temporary lateral distance corresponding to the correlation coefficient.

18. The phase correction method of claim 16, wherein the second range-Doppler map is generated by values having peak power.

19. The phase correction method of claim 11, wherein the changing the preset phase correction value includes periodically accumulating the difference between the first phase value and the second phase value, and determining that the phase correction is necessary if an average of the accumulated difference exceeds a preset threshold value, and changing the preset phase correction value based on the average of the accumulated difference.

20. A phase correction device comprising:
at least one memory storing computer program instructions; and
at least one processor for executing the computer program instructions,
wherein the at least one processor is configured to,
transmit and receive a radar signal through a plurality of transmitting antennas and a plurality of receiving antennas;
select a target among objects detected by a host vehicle based on a state of the host vehicle while in motion and a preset criterion;
measure a first phase value based on the radar signal reflected and received from the target, and determine a second phase value corresponding to an azimuth of the target based on a preset phase correction value; and
determine a necessity of phase correction by comparing the first phase value and the second phase value, and change the preset phase correction value based on a difference between the first phase value and the second phase value in response to determination of the necessity of phase correction.
